(19) United States
(12) Patent Application Publication
(10) Pub. No.: US 2006/0053280 A1
(43) Pub. Date: Mar. 9, 2006

(54) Secure e-mail messaging system

(76) Inventors: Donald E. Kittle, Toronto (CA); Christopher Pape, King City (CA)

Correspondence Address: BERESKIN AND PARR, 40 KING STREET WEST, BOX 401, TORONTO, ON, M5H 3Y2, CA

(21) Appl. No.: 11/217,348

(22) Filed: Sep. 2, 2005

Related U.S. Application Data
(60) Provisional application No. 60/606,435, filed on Sep. 2, 2004.

(51) Int. Cl. H04L 9/00

(52) U.S. Cl. 713/156

(57) ABSTRACT

A method and system for the secure transmission of electronic mail from a sender device to a recipient device, where at an e-mail server an e-mail sent from a sender device is received, where the e-mail may be encrypted with a sender personal key, or transmitted over a secure communiation channel. The e-mail server may then, if the e-mail from the sender device has been encrypted, decrypt the sender encrypted e-mail with a sender server key to produce a server decrypted e-mail, and then encrypts the server decrypted e-mail with a recipient server key to produce a server encrypted e-mail. The e-mail server then transmits the server encrypted e-mail to a recipient device where the server encrypted e-mail is decrypted with a recipient personal key.

### CROSS REFERENCE

This application claims priority from U.S. Provisional Application Ser. No. 60/606,435 filed on Sep. 2, 2004.

### FIELD OF THE INVENTION

The present invention relates generally to a system and method for securely transmitting e-mail messages over a communication network.

### BACKGROUND OF THE INVENTION

Electronic mail or e-mail communication is widely employed by many individuals whose professional or personal activities require that communications be sent and received in confidence. For example, attorneys are required to ensure that communications between themselves and their clients always remain confidential.

Many e-mail messages are exchanged between a sender and a recipient over a public network, such as the Internet. Data communicated over the Internet is susceptible to being intercepted and read or even altered. As a result, the recipient of an e-mail has no way of conclusively knowing whether an e-mail message has been read by a third party or if it has been modified before receipt.

Typically, a sender composes an e-mail message using an e-mail client (for example, Outlook, Outlook Express, Eudora mail, etc). When the sender sends the message, the e-mail message is transmitted from the sender's computer to what is known as a mail transfer agent (MTA) or outgoing mail server so that it may be relayed toward its intended recipient. The Internet service provider (ISP) that provides the sender's Internet connection also commonly provides access to the outgoing mail server. When the e-mail message reaches the outgoing mail server, the outgoing mail server analyzes the ‘to’ field in the e-mail message to determine the recipients and in turn determine which server will accept e-mail for the domain name that is associated with the recipient. In order to transmit the e-mail message to the intended recipient, it may be transmitted to various servers on the Internet until it reaches a destination server. Copies of the e-mail message are stored on each of these servers, at least temporarily. As the e-mail message may be transmitted between a multitude of servers, it is conceivable that it may be viewed or altered at any of these points. Therefore, due to the sensitive nature of much of the communication that is conducted via e-mail, where confidentiality is of the utmost importance, it becomes very important to provide a mechanism by which e-mail messages can be sent from a sender to a recipient without being viewed or altered.

One solution to ensuring secure e-mail communication involves the use of encryption. Encryption prevents unauthorized parties from reading or tampering with data. When encryption is applied to e-mail, the e-mail message is scrambled, and it can only be read after decryption. A sender typically encrypts an e-mail message and sends it to one or more recipients who then decrypt the message and read it. E-mail encryption is generally based on public key cryptography, which implements an asymmetric scheme that relies on a pair of keys for encryption. A public key and a corresponding private key are relied upon to encrypt and decrypt an e-mail message.

Public key cryptography for e-mail facilitates secure communication between individuals. With public key encryption applied to e-mail, the sender and receiver are not required to exchange their secret (or private) key in order to be able to send and receive secure communications between one another. However, for a sender to send an encrypted message to a recipient, the sender must have the recipient's public key to encrypt the message.

A sender who communicates with a large number of recipients must obtain and manage a large number of public keys and must properly encrypt each message sent to each recipient. This process can be cumbersome and can be further complicated if the public keys expire periodically, forcing the sender to obtain new public keys for the recipients or to obtain confirmations that the expiry date of a public key has been extended.

There is accordingly a need for a secure e-mail transmission system that simplifies the use of encryption keys by a sender who wishes to communicate electronically with multiple recipients.

### SUMMARY OF THE INVENTION

The invention provides a system and method for securely transmitting e-mail messages between registered users of the system. Each registered user has a personal key and a server key, which are a complementary pair of keys that may be used to encrypt data.

The personal key is transmitted to the registered user, possibly as part of a security certificate. Each registered user's e-mail client operating on the registered user's communication device, such as a personal computer, digital cell phone, personal digital assistant or other device, is configured to encrypt secure e-mail messages using the registered user's personal key and to transmit them through the secure e-mail server. The e-mail client is also configured to decrypt secure e-mail messages received from the secure e-mail server using the registered user's personal key. The user maintains the personal key securely as a private key, so that it is not available to third parties. In some embodiments of the invention, the user may be required to enter a password or pass-phrase to utilize the personal key, thereby ensuring that unauthorized persons with access to the user's communication device cannot use or otherwise access the user's personal key.

The server key is securely stored in a key registry in a secure e-mail server that is part of the system. The user's server key is maintained securely by the secure e-mail server as a private key.

In this first embodiment, the user's personal and server keys are asymmetric, or different, keys. Since both keys are kept private, this embodiment may be said to utilize asymmetric private-key cryptology. In other embodiments of the invention, an asymmetric public-key system may be used where each user's personal key is a private key and the user's server key is a public key that could be disclosed to third parties. In other embodiments, a symmetric private-key system may be used.

One of the registered users, referred to as a sender, may transmit a secure e-mail message to another one of the registered users, referred to as a recipient. The sender composes the e-mail message. The sender securely transmits the e-mail message to the secure e-mail server. To ensure the security of the e-mail message, the sender may transmit the e-mail message to the secure e-mail server using a secure communication protocol such as Secure Sockets Layer (SSL) or Transport Security Layer (TLS). Alternatively, or additionally, the sender may encrypt the message using the sender's personal key. The sender may also optionally digitally sign the message using the sender's personal key. The sender's e-mail client may be configured to perform these encryption and signing steps automatically when the sender transmits an e-mail message to the secure e-mail server. The secure e-mail server receives the secure e-mail message and decrypts it using the sender's server key. The secure e-mail server then encrypts the e-mail message using the recipient's server key and transmits it to the recipient's communication device. The recipient's e-mail client decrypts the e-mail message using the recipient's personal key. The recipient is thus able to receive the e-mail message securely without knowing the sender's personal or server key.

In one embodiment of the invention, registered users are divided into primary users and secondary users who are associated with the primary users. Each primary user pays a fee for the use of the system and method, but the secondary users pay either no fee or a reduced fee compared to that paid by the primary user. The primary user may communicate with any of the secondary users associated with the primary user or with any other primary user and may also receive messages from any of those secondary users or primary users. Secondary users may optionally be permitted to transmit secure e-mail messages to other secondary users associated with the same primary user.

In another embodiment, registered users are not distinguished as primary users and associated secondary users. A registered user is permitted to transmit secure e-mail messages to other registered users.

These and other aspects of the invention are further described below.

### BRIEF DESCRIPTION OF THE DRAWINGS

The invention will now be described, by way of example only, with reference to the drawings, in which:

FIG. 1 is a block diagram of a conventional e-mail system;

FIG. 2 is a block diagram of a e-mail system according to the present invention;

FIG. 3 is a block diagram of a secure e-mail server of the system of FIG. 2;

FIG. 4 illustrates a method for registering users; and

FIG. 5 illustrates a method for sending a secure e-mail message according to the present invention.

### DETAILED DESCRIPTION OF EMBODIMENTS OF THE INVENTION

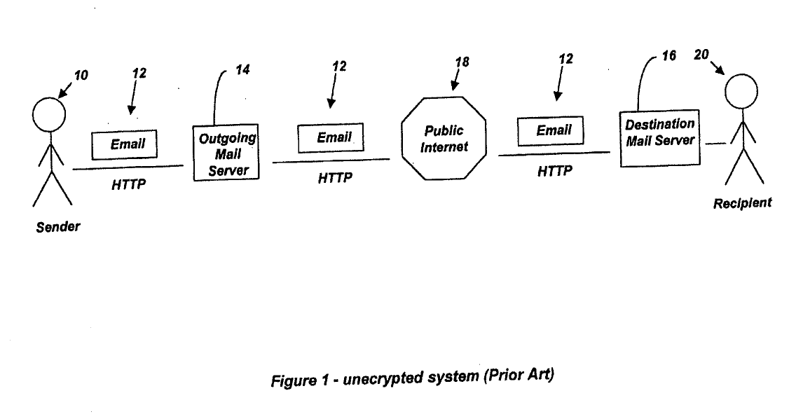

Reference is made to FIG. 1, where a conventional system for transmitting unencrypted e-mail messages is shown. A sender 10 composes an e-mail message 12 using an e-mail client (such as Microsoft Outlook™, Outlook Express™, Eudora™, Pegasus™, or e-mail clients that are accessed through a web service such as those belonging to Hotmail™ or Yahoo™). E-mail message 12 is transmitted to an outgoing mail server 14. The e-mail message 12 is analyzed at the outgoing mail server 14 in order to determine who the intended recipients of the e-mail message 12 are. The outgoing mail server 14 transmits the message to a destination mail server 16. In many cases, an email message 12 is transmitted from the outgoing mail server 14 to the destination mail server 16 via the Internet 18. As the e-mail message 12 is transmitted through the Internet, it is possible and likely that the e-mail message 12 is transmitted to a number of intermediate servers coupled or interconnected between the outgoing mail server 14 and the destination mail server 16. A copy of the e-mail message 12 is recorded, at least temporarily, in each one of these servers. As the e-mail message 12 that is depicted in this prior art system is not secure, in that it is not encrypted, it is possible that prior to reaching the destination mail server 16, its integrity may have been compromised, in that it may have been accessed and or altered by an unauthorized source. Once the e-mail message 12 is received at the destination mail server 16, a recipient 20 is able to access the e-mail message 12 by connecting to the destination mail server 16.

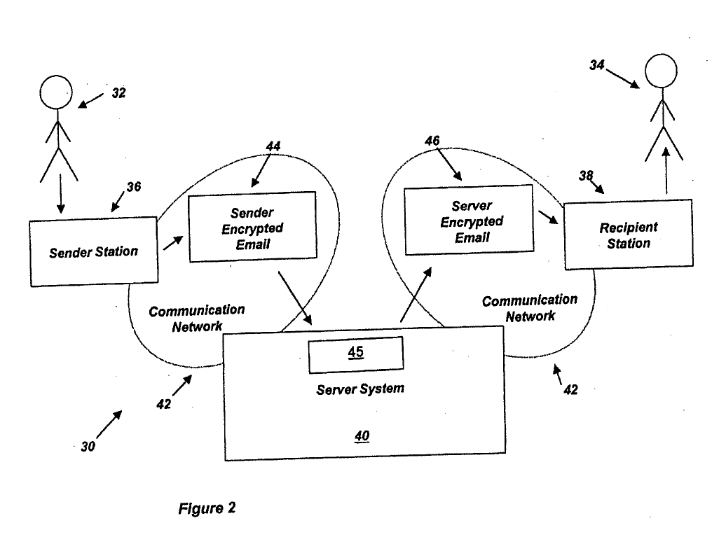

Reference is now made to FIG. 2, which illustrates a secure electronic communication system 30 according to the present invention. A sender 32 can use system 30 to securely exchange e-mail messages with a recipient 34. A sender station 36 and a recipient station 38 are connected to a secure e-mail server 40 through a communication network 42. Secure e-mail server 40 is operated by a system operator (not shown). Sender 32 uses the sender station 36 and recipient 34 uses recipient station 38.

The sender station 36 and recipient station 38 may be any type of device that allows the sender or receiver to communicate using communication network 42. For example, the sender station 36 and recipient station 38 may be personal computers, wireless handheld communication devices, cellular phones with data communication capabilities or any other type of computing device, that allows for electronic communication.

The communication network 42 may be the Internet, or any other communication system or means through which secure e-mail server 40 can communicate with the sender station 36 and the recipient station 38.

The sender 32 and receiver 34 are “users” of system 30 and they use a secure e-mail communication service provided and managed by the system operator through secure e-mail server 40. Each user of system 30 must be registered to use the system to transmit or receive secure e-mail messages. Many other users, in addition to sender 32 and receiver 34 may be registered to use the service.

In the present embodiment, which may be used by professional advisors and others who wish to exchange secure e-mail messages with a number of other persons (such as their clients), some users are primary users and others are secondary users. Each secondary user is associated with a primary user. Each primary user registers with the system operator and identifies secondary users who may then receive secure e-mail messages from the primary user and send secure e-mail messages to the primary user.

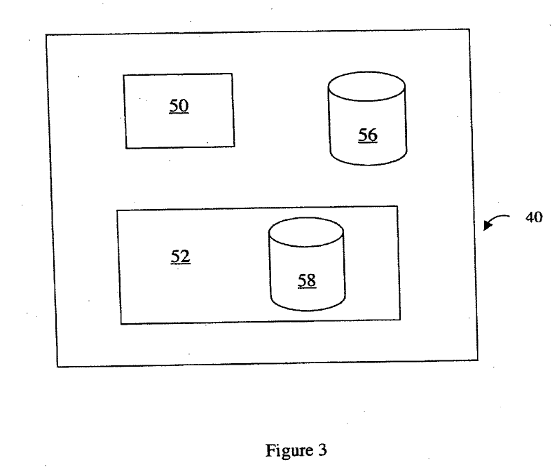

Reference is next made to FIG. 3, which illustrates one embodiment of the secure e-mail server 40 in greater detail. Secure e-mail server 40 includes a mail relaying module 50, user registry 56 and a key manager module 52. The key manager module 52 includes a key registry 58.

Mail relaying module 50 interfaces with communication network 42 to receive and transmit electronic mail messages from and to the sender station 36 and the receiver station 38. In alternative embodiments, the key manager module and user registry can be located upon the recipient and/or sender devices.

Key manager module 52 manages and stores, in the key registry 58, encryption keys used to decrypt and encrypt secure e-mail messages received from and transmitted to the sender station 36 and the receiver station 38.

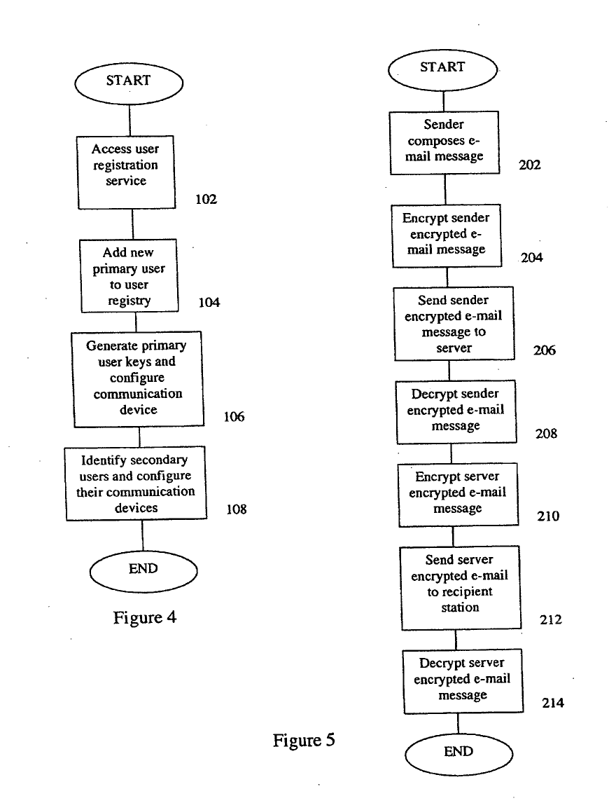

Reference is next made to FIG. 4, which illustrates a method 100 by which a person may register to become a primary user of system 30. Method 100 begins in step 102, in which a person accesses a user registration service provided by the secure e-mail server 40. Secure e-mail server 40 includes one or more interfaces that allow a person to provide information about himself, herself or about the person's business, such as identification information (such as the person's or business's name), contact information, billing information and other information that the system operator may specify. The interfaces may include websites with web pages that allow the user to enter the required information. In addition or alternatively, the system operator may allow the user to provide the required information and to register by providing the required information on a paper form or by telephone. Such manually collected information may later be inputted into the secure e-mail server 40 to register a user.

In the present embodiment, the secure e-mail server 40 includes a website that may be accessed by a person using communication network 42 or another communication network. The website includes a registration web page. The registration web page allows the person to register himself, herself or a user as a primary user of system 30.

In the present embodiment, the service provider has specified that each user must provide the user's name, contact information and billing information.

The contact information must include an e-mail address that will be used with system 30. In other embodiments of the invention, the system operator may specify that additional or different information is required from a person who wishes to register or that some of the information is optional.

The billing information may be information related to a credit card, debit card, bank account or any other type of payment system or account that the service provider may use to obtain payment for usage of system 30.

Method 100 then proceeds to step 104 in which the entity being registered is added to the user registry 56, if the information provided in step 102 satisfies any criteria specified by the service provider. If the information does not comply with any such requirements, then method 100 may end or may return to step 102 to allow the information to be corrected.

In this embodiment, the entity being registered is identified in the user registry 56 as a primary user. The newly registered user is then a primary user of system 30.

Method 100 then proceeds to step 106 in which the secure e-mail server 40 generates a complementary pair of personal and server keys for the primary user. The primary user's server key is recorded in the key registry 58. The primary user's personal key is transmitted to the primary user. In addition, instructions for configuring the primary user's communication device are transmitted to the primary user. Typically, the primary user's personal key and the instructions are transmitted to the primary user by downloading them or by e-mail. The instructions for configuring the primary user's communication device may include text instructions for configuring an e-mail client used by the primary user at the primary user's communication device to configure the communication device to communicate with the secure e-mail server 40. The user may follow the text instructions to configure the communication device. Additionally or alternatively, the instructions may include a program executable at the primary user's communication device to automatically configure the device. In the present embodiment, the instructions configure the primary user's e-mail client to (i) use the secure e-mail server 40 as the primary user's outgoing e-mail server, (ii) encrypt e-mail messages transmitted to the secure e-mail server 40 using the primary user's personal key and (iii) decrypt e-mail message received from the secure e-mail server 40 using the primary user's personal key. In other embodiments, the instructions may not configure the user's e-mail client to encrypt e-mail message transmitted to the secure e-mail server 40 using the primary user's personal key. In such embodiments, an alternate security mechanism, such as SSL or TLS may be used to secure the e-mail message as it is transmitted to the secure e-mail server 40.

Method 100 then proceeds to step 108 in which the primary user may specify one or more secondary users who will be associated with the primary user. Typically, the primary user will enter at least an e-mail address for each secondary user. The primary user may also provide additional information for the secondary users.

For each secondary user, the secure e-mail server generates a complementary pair of secondary user's personal and server keys. Each secondary user's server key is recorded in the key registry 58. Each secondary user's personal key is transmitted to the secondary user along with instructions for configuring the secondary user's communication device, in the same manner as is described above in relation to the primary user's communication device. At each secondary user's communication device, the secondary user's e-mail client is configured to (i) use the secure e-mail server 40 as the secondary user's outgoing e-mail server, (ii) encrypt e-mail messages transmitted to the secure e-mail server 40 using the secondary user's personal key and (iii) decrypt e-mail message received from the secure e-mail server 40 using the secondary user's personal key.

In step 108, each secondary user is added to the user registry and is identified as a secondary user of system 30. The secondary user is identified as being associated with the primary user registered in step 104.

Method 100 then ends.

In one embodiment of the invention, a primary user is permitted to identify up to one hundred secondary users who may then exchange secure e-mail messages with the primary user. The primary user is charged a fee for this service. The primary user may add additional secondary users in exchange for an additional fee. In other embodiments, the primary user may be charged a fee for each secondary user that is associated with the primary user. In embodiments where the users are not distinguished as primary and secondary users, the users may be charged a service charge to use system 30 on a periodic basis, based on their use of system 30 or based on a combination of these types of charges.

A particular user may have multiple registrations in the user registry 56. For example, a user may be a primary user associated with one or more secondary users. At the same time, the same user may be a secondary user of one or more other primary users, and will have a separate association with each of those primary users.

After completing method 100, a primary user may associate additional secondary users with the primary user and may also remove secondary users associated with the primary user using the interfaces provided in the secure e-mail server 40.

Reference is next made to FIG. 5, which illustrates a method 200 be which a secure e-mail message is transmitted from a sender station 36 to a recipient station 38. In the present invention, a primary user may send a secure e-mail to a user associated with that primary user or to another primary user. Also, a secondary user may send a secure e-mail message to the associated primary user. In other embodiments, secondary users associated with the same primary user may also be permitted to send secure e-mail messages to one another. In other embodiments, users may simply be registered with the secure e-mail server, without identifying them as primary or secondary users. In such an embodiment, any of the users may be permitted to send secure e-mail messages to any other user, or to any other user identified as a member of a group of users. In other embodiments, it will be possible for both primary and secondary users to specify their own encryption keys that are to be used in the system 30.

In method 200, the sender station 36 is used by a sender 32 and the receiving station 38 is used by a receiver 34. For example, the sender may be a primary user of system 30 and the recipient may be a secondary user of system 30. A primary user may send a single secure e-mail message to a plurality of associated secondary users, each of whom may be considered a receiver of the message. In other embodiments, any pair of users that can exchange messages may be the sender and receiver. Method 200 will be described in the context of an e-mail message being transmitted from a primary user to a secondary user associated with the primary user.

Method 200 begins in step 202, in which the sender composes an e-mail message at the sender station 36, using the e-mail client configured in step 108. The sender specifies at least one recipient for the message. In the present embodiment, if the sender is a primary user, a secondary user associated with the primary user or another primary user may be specified as the recipient. The primary user may also specify any combination of one or more primary or secondary users to receive the e-mail message. If the sender is a secondary user, then the associated primary user is specified as the recipient.

Method 200 then proceeds to step 204, in which the e-mail message composed by the sender is encrypted using the sender's personal key. This step is carried out automatically by the sender's e-mail client, which is configured to carry out this step in step 106 of method 100. The resulting encrypted e-mail message is illustrated in FIG. 2 as sender encrypted e-mail message 44.

Method 200 then proceeds to step 206, in which the sender encrypted e-mail message 44 is transmitted from the sender station 36 to secure e-mail server 40. The identity of the sender is also transmitted with sender encrypted e-mail message 44.

The sender encrypted e-mail message 44 may be transmitted from the sender station 36 to the secure e-mail server 40 using any communication protocol. For example, a protocol such as secure socket layer (SSL) may be used. Alternatively, any other method may be used. For example, if the communication network is the Internet, the sender encrypted e-mail message may be transmitted as one or more TCP/IP packets.

Step 204 of method 200 may be an optional step. In some embodiments of the invention, including the present exemplary embodiment, the sender station 36 may use a secure communication protocol such as Secure Sockets Layer (SSL) or Transport Security Layer (TSL) to transmit the sender's e-mail message to the secure e-mail server 40. As a result, it is not necessary for the sender to encrypt the sender's e-mail message using the sender's personal key. When using a secure communication protocol, the sender will typically be required to authenticate using authentication information that identifies the sender. The sender's e-mail client may be configured to automatically authenticate the sender by sending the authentication information to the secure e-mail server 40.

As part of step 204 or in the place of step 204, the sender may also optionally digitally sign the sender's e-mail using the sender's personal key (or using another key specific to the sender) to provide further assurance to the recipient that the sender's e-mail did originate from the sender. The sender may choose to sign the sender's e-mail whether the sender chooses to encrypt the sender's e-mail in step 204 or not.

Method 200 then proceeds to step 208 in which mail relaying module 52 in the secure e-mail server 40 receives the sender encrypted e-mail message 44. The secure e-mail server 40 decrypts it using the sender's server key, which is recorded in the key registry 58, as described above in relation to step 106 and 108. Key manager module 52 uses the identity of the sender to retrieve the sender's server from the key registry 58. The resulting decrypted e-mail message corresponding to the original e-mail message composed by the sender in step 202 is illustrated in FIG. 2 as decrypted e-mail message 45.

Method 200 then proceeds to step 210. Using the recipient name identified in the decrypted e-mail message 45, the key manager module retrieves the recipient's server key from key registry 58. The secure e-mail server 40 encrypts the decrypted e-mail message 45 using the recipient's server key to generate a server encrypted e-mail message 46.

If the e-mail message identifies more than one recipient, steps 208 to 212 are performed for each recipient, so that each recipient receives a copy of the e-mail message.

Method 200 then proceeds to step 212, in which the secure e-mail server 40 transmits the server encrypted e-mail message 46 to the recipient station 38 using communication system 42.

Method 200 then proceeds to step 214, in which the recipient e-mail client operating on the recipient station 38 decrypts the server encrypted e-mail message using the recipient's personal key. The resulting decrypted e-mail message corresponds to the original e-mail message composed by the sender in step 202 and may be viewed by the recipient. The recipient is able to receive and view the e-mail message without having the sender's personal key (or the sender's server key).

In the present embodiment, secondary users cannot send e-mail message to one another using system 30. Either the sender or the recipient of each e-mail message must be a primary user. In another embodiment, secondary users that are associated with the same primary user may be permitted to transmit e-mail messages to one another. The secondary user that originates such an e-mail message is the sender of the e-mail message. The secondary user (and other users, possibly including the associated primary user and other secondary users) are the recipients of the e-mail message. In such an embodiment, a group of secondary user who communicate with the primary user and who also communicate with each other can use e-mail features such as “Reply to all recipients” to respond to an e-mail message to multiple recipients. For example, if a primary user is a lawyer who works with a group of people employed by a client, the client's will be able to send an e-mail message to the lawyer and their own co-workers.

In another embodiment where user are registered without identifying them as primary or secondary users, a user may be permitted to send an e-mail message to any group of recipients. In other embodiments, other restrictions may be imposed by the service provider.

Method 200 then ends.

E-mail messages commonly include attachments in the form of files included with an e-mail message. In the present embodiment, attachments to a secure e-mail message are encrypted in steps 204 and 210 and decrypted in step 208 together with the body of the secure e-mail message.

In other embodiments of the present invention, secure e-mail server 40 includes an optional attachment control module. Attachments to secure e-mail messages are encrypted and decrypted in step 204 and 208 using the sender's personal and server keys as described above. Each attachment to a message is then recorded in an attachment database in the secure e-mail server 40. The attachment is then made available over communication network 42 to recipients of the secure e-mail. The body of the secure e-mail message is modified by adding a link to the attachment. The body of the secure e-mail message is encrypted, including the added link. When the recipient views the secure e-mail message, the recipient may access the attachment by using the link. To ensure that the attachment is available only to authorized recipients, the link may encode an authorization code, or alternatively, the recipient's e-mail client may identify itself using the recipient's personal key or using some other security mechanism. For example, the recipient's access to an attachment may be through a secure communications link that uses the SSL, TLS or another security protocol. The recipient may be required to provide a username and a password to access an attachment.

While using system 30 a registered user may attempt to transmit a secure e-mail message to an e-mail address that is not associated with a registered user. In this case, during step 210, the key manager module 52 will not find any entry in the key registry 58 corresponding to the recipient address.

In an embodiment that identifies registered users as primary and secondary users, secure e-mail server 40 may be configured to transmit a message to the sender indicating that the recipient is not registered to use system 30. If the sender is a primary user, then the primary user may add the recipient as a secondary user associated with the primary user. If the recipient is a registered is a registered user, but is not associated with the sender, system 30 may take the same action.

In an embodiment in which registered users are not distinguished as primary or secondary users, the secure e-mail server may transmit a message to the indicated recipient e-mail address indicating that the sender is attempting to transmit a secure e-mail message to the recipient and providing instructions informing the recipient how it may become a registered user of system 30. When the recipient becomes a registered user, secure e-mail server 40 can forward the secure e-mail message in accordance with steps 210 to 214 of method 200. Alternatively, secure e-mail server 40 may be configured to transmit a message to the sender indicating that the recipient is not a registered user and asking if the message should be forwarded to the recipient as an unsecure message. If the sender chooses this option, the secure e-mail server 40 may forward an unencrypted version of the e-mail message to the recipient.

It should be understood that various modifications can be made to the embodiments described and illustrated herein, without departing from the invention, the scope of which is defined in the appended claims.

We claim:

1) A method of providing secure electronic mail communication, comprising:
a) receiving at an e-mail server a sender encrypted e-mail encrypted at a sender device with a sender personal key;
b) decrypting at the e-mail server the sender encrypted e-mail with a sender server key to produce a server decrypted e-mail;
c) encrypting at the e-mail server the server decrypted e-mail with a recipient server key to produce a server encrypted e-mail;
d) transmitting the server encrypted e-mail to a recipient device where the server encrypted e-mail is decrypted with a recipient personal key.

2) The method of claim 1, where the sender personal key and the sender server key form a public/private key pair.

3) The method of claim 1, where the recipient server key and the recipient personal key form a public/private key pair.

4) The method of claim 1, where the sender personal key and the sender server key are identical.

5) The method of claim 1, where the recipient personal key and the recipient server key are identical.

6) The method of claim 1, where the sender encrypted e-mail is signed by the sender personal key.

7) The method of claim 1, where the sender encrypted e-mail includes information used to identify the sender and recipient.

8) A computer-readable medium comprising a software application recorded on the computer-readable medium, wherein the software application includes instructions for providing a method of secure electronic mail communication as claimed in claim 1.

9) A method of providing secure electronic communication, comprising
a) receiving at an e-mail server a sender transmitted e-mail message transmitted from a sender station though a secure communication protocol;
b) encrypting at the e-mail server the sender decrypted e-mail with a recipient server key to produce a server encrypted e-mail;
c) transmitting the server encrypted e-mail to a recipient device where the server encrypted e-mail is decrypted with a recipient personal key.

10) The method of claim 9, wherein the secure communication protocol is a secure socket layer connection.

11) The method of claim 9, wherein the secure communication protocol is a transport layer connection.

12) The method of claim 9, wherein the e-mail message is signed by a sender personal key.

13) The method of claim 9, where the recipient server key and the recipient personal key form a public/private key pair.

14) The method of claim 9, where the recipient personal key and the recipient server key are identical.

15) The method of claim 9, where the sender encrypted e-mail is signed by the sender personal key.

16) The method of claim 9, where the sender encrypted e-mail includes information used to identify the sender and recipient.

17) A computer-readable medium comprising a software application recorded on the computer-readable medium, wherein the software application includes instructions for providing a method of secure electronic mail communication as claimed in claim 9.

18) A method of providing a secure e-mail exchange service allowing a primary user to exchange secure electronic mail messages with one or more secondary users, the method comprising:
a) providing a secure e-mail server including a user registry, a key manager module and a mail relaying module;
b) registering the primary user by creating a record for the primary user in the user registry, wherein the primary user's record includes a server key assigned to the primary user;
e) allowing the primary user to identify one of more secondary users;
d) registering at least some of the secondary users by creating a record for each of the registered secondary users in the user registry, wherein each registered secondary user's record includes a server key assigned to the secondary user;
e) associating each registered secondary user with the primary user; and
e) facilitating secure e-mail communication between the primary user and one of the associated secondary users.

19) The method of claim 18 further including charging a fee to the primary user for providing the secure e-mail exchange service and including providing the secure e-mail exchange service to the secondary user at no charge.

20) The method of claim 19 wherein the primary user is permitted to identify a limited number of secondary users.

21) A system for the secure transmission of electronic mail comprising:
a) a key manager module; and
b) a mail relay module adapted to receive from a sender device a sender encrypted email encrypted at a sender device with a sender personal key and to decrypt the sender encrypted email to produce a server decrypted email with a sender server key to produce a server decrypted email, and to encrypt the server decrypted email with a recipient server key and to produce a server encrypted email and to transmit the server encrypted email to a recipient device.

22) The system of claim 21 wherein the key manager module is comprised of one or more server keys associated with one or more primary users, and one or more server keys associated with one or more secondary users.
